(19) United States
(12) Patent Application Publication
(10) Pub. No.: US 2024/0112590 A1
(43) Pub. Date: Apr. 4, 2024

(54) SYSTEM AND METHOD FOR SUPPORTING DYNAMIC SPACED RETRIEVAL WITH A LEARNING ASSESSMENT ENGINE

(71) Applicant: MEDSTUDY CORPORATION, Colorado Springs, CO (US)

(72) Inventor: Robert Anthony Hannaman, Colorado Springs, CO (US)

(21) Appl. No.: 17/959,046

(22) Filed: Oct. 3, 2022

(51) Int. Cl. G09B 5/12; G06Q 50/20

(52) U.S. Cl. CPC G09B 5/12; G06Q 50/205

(57) ABSTRACT

Embodiments of the present disclosure provide systems and methods for online learning in which a review or retrieval activity is performed a dynamically variable intervals to re-enforce learning and retention. A study plan can be developed and customized for individual students. Content for a course of study can be presented according to this study plan as a sequence of activities including a study activity to present the course content and a retrieval activity to review and assess the student's mastery and retention of the content. A time interval between the study activity and the retrieval activity can be variable and dynamically determined based on the individual student's performance.

### FIELD OF THE DISCLOSURE

Embodiments of the present disclosure relate generally to methods and systems for online learning and more particularly to online learning in which a review or retrieval activity is performed a dynamically variable intervals to re-enforce learning.

### BACKGROUND

Online learning, also referred to as e-learning, distance learning, distance education, virtual classrooms, and similar, refers to a set of services provided over a network such as the Internet that allows students to access content of a course of study remotely for the purpose of learning. Such services allow students and teachers to participate in the educational process without a need to be present in a physical classroom.

Online learning provides many advantages but also present many challenges. For example, course content and organization, i.e., the student's lesson plan, can be tailored to each student's needs providing a potentially more effective approach. However, such customization typically requires close monitoring of each student's progress and intervention by a teacher or faculty member to make adjustments to the student's lesson plan. This is especially challenging in higher education and advanced studies with a large volume of content that must be mastered such as in medical education, for example. Hence, there is a need for improved methods and systems for online learning that provide for customization of delivery of lessons in a course of study without requiring extensive intervention from a teacher or other faculty.

### BRIEF SUMMARY

Embodiments of the present disclosure provide systems and methods for online learning in which a review or retrieval activity is performed a dynamically variable intervals to re-enforce learning. According to one embodiment, a method for conducting online learning can comprise maintaining a set of study units in one or more repositories. Each study unit of the set of study units can comprise a collection of related content.

A study plan can be defined. The study plan can comprise a sequence of a plurality of study units from the set of study units to be completed within a specified period of time and a pace defining a timeline for completing the sequence of the plurality of study units in the study plan within the specified period of time. Defining the study plan can further comprise receiving information defining one or more study goals for the user of the student system, receiving a selection of content for the set of study units, dividing the received selection of content into individual study units of the set of study units, organizing the plurality of study units in the lesson plan into an order defined by the study plan, receiving a start date and an end date for the specified period of time for the study plan and calculating the pace for the study plan based on the start date and the end date for the specified period of time and the plurality of study units in the study plan.

A study activity can be provided based on the study plan. The study activity can comprise presentation of at least one study unit from the sequence of the plurality of study in the study plan to a user of the student system. In some cases, a preview activity comprising a presentation of one or more next study units in the study plan can be provided before the study activity is provided.

A retrieval activity comprising presentation of the at least one study unit from the study activity can be provided after the study activity is completed. A time interval between completion of the study activity and the retrieval activity can be dynamically determined based performance of the user of the student system. Providing the retrieval activity can comprise collecting a set of metrics from the results of the study activity, the set of metrics indicating performance of the user of the student system, determining time interval between completion of the completed study unit and the retrieval activity based on the set of metrics, providing the presentation of the at least one study unit to the student system, providing feedback on the retrieval activity based on performance of the user of the student system during the retrieval activity, and updating the set of metrics in the results based on the performance of the user of the student system during the retrieval activity.

Results of the study activity and retrieval activity can be tracked and the study plan can be adjusted based on the tracking of the results of the study activity and the retrieval activity. Adjusting the study plan can comprise providing a summary of current performance of the user of the student system on the study plan and determining, based on the current performance of the user of the student system on the study plan, whether the user of the student system is on the pace defined for the study plan. In response to determining the user of the student system is not on the pace defined for the study plan, a new pace for the study plan can be suggested, an indication of a selection of a new pace for the study plan can be received, and the study plan can be updated with the new pace.

According to another embodiment, a system can comprise a processor and a memory coupled with and readable by the processor. The memory can store therein a set of instructions which, when executed by the processor, causes the processor to maintain a set of study units in one or more repositories. Each study unit of the set of study units comprising a collection of related content.

The instructions can further cause the processor to define a study plan comprising a sequence of a plurality of study units from the set of study units to be completed within a specified period of time and a pace defining a timeline for completing the sequence of the plurality of study units in the study plan within the specified period of time. Defining the study plan can comprise receiving information defining one or more study goals for the user of the student system, receiving a selection of content for the set of study units, dividing the received selection of content into individual study units of the set of study units, organizing the plurality of study units in the lesson plan into an order defined by the study plan, receiving a start date and an end date for the specified period of time for the study plan, and calculating the pace for the study plan based on the start date and the end date for the specified period of time and the plurality of study units in the study plan.

The instructions can further cause the processor to provide to a student system, a study activity based on the study plan, wherein the study activity comprises presentation of at least one study unit from the sequence of the plurality of study in the study plan to a user of the student system. In some cases, the instructions can further cause the processor to provide a preview activity comprising a presentation of one or more next study units in the study plan before providing the study activity.

The instructions can further cause the processor to provide a retrieval activity comprising presentation of the at least one study unit from the study activity after the study activity is completed. A time interval between completion of the study activity and the retrieval activity can be dynamically determined based performance of the user of the student system. Providing the retrieval activity can comprises collecting a set of metrics from the results of the study activity, the set of metrics indicating performance of the user of the student system, determining time interval between completion of the completed study unit and the retrieval activity based on the set of metrics, providing the presentation of the at least one study unit to the student system, providing feedback on the retrieval activity based on performance of the user of the student system during the retrieval activity, and updating the set of metrics in the results based on the performance of the user of the student system during the retrieval activity.

The instructions can further cause the processor to track results of the study activity and the retrieval activity and adjust the study plan based on the tracking of the results of the study activity and the retrieval activity. Adjusting the study plan can comprise providing a summary of current performance of the user of the student system on the study plan and determining, based on the current performance of the user of the student system on the study plan, whether the user of the student system is on the pace defined for the study plan. In response to determining the user of the student system is not on the pace defined for the study plan, the instructions can cause the processor to suggest a new pace for the study plan to the user of the student system through the student system, receive an indication of a selection of a new pace for the study plan from the student system, and update the study plan with the new pace.

According to yet another embodiment, a non-transitory, computer-readable medium can comprise a set of instructions stored therein which, when executed by a processor, causes the processor to maintain a set of study units in one or more repositories. Each study unit of the set of study units comprising a collection of related content.

The instructions can further cause the processor to define a study plan comprising a sequence of a plurality of study units from the set of study units to be completed within a specified period of time and a pace defining a timeline for completing the sequence of the plurality of study units in the study plan within the specified period of time. Defining the study plan can comprise receiving information defining one or more study goals for the user of the student system, receiving a selection of content for the set of study units, dividing the received selection of content into individual study units of the set of study units, organizing the plurality of study units in the lesson plan into an order defined by the study plan, receiving a start date and an end date for the specified period of time for the study plan, and calculating the pace for the study plan based on the start date and the end date for the specified period of time and the plurality of study units in the study plan.

The instructions can further cause the processor to provide to a student system, a study activity based on the study plan, wherein the study activity comprises presentation of at least one study unit from the sequence of the plurality of study in the study plan to a user of the student system. In some cases, the instructions can further cause the processor to provide a preview activity comprising a presentation of one or more next study units in the study plan before providing the study activity.

The instructions can further cause the processor to provide a retrieval activity comprising presentation of the at least one study unit from the study activity after the study activity is completed. A time interval between completion of the study activity and the retrieval activity can be dynamically determined based performance of the user of the student system. Providing the retrieval activity can comprises collecting a set of metrics from the results of the study activity, the set of metrics indicating performance of the user of the student system, determining time interval between completion of the completed study unit and the retrieval activity based on the set of metrics, providing the presentation of the at least one study unit to the student system, providing feedback on the retrieval activity based on performance of the user of the student system during the retrieval activity, and updating the set of metrics in the results based on the performance of the user of the student system during the retrieval activity.

The instructions can further cause the processor to track results of the study activity and the retrieval activity and adjust the study plan based on the tracking of the results of the study activity and the retrieval activity. Adjusting the study plan can comprise providing a summary of current performance of the user of the student system on the study plan and determining, based on the current performance of the user of the student system on the study plan, whether the user of the student system is on the pace defined for the study plan. In response to determining the user of the student system is not on the pace defined for the study plan, the instructions can cause the processor to suggest a new pace for the study plan to the user of the student system through the student system, receive an indication of a selection of a new pace for the study plan from the student system, and update the study plan with the new pace.

### BRIEF DESCRIPTION OF THE DRAWINGS

FIG. 1 is a block diagram illustrating elements of an exemplary online learning environment in which embodiments of the present disclosure may be implemented.

FIG. 2 is a block diagram conceptually illustrating an exemplary progression though online learning activities according to one embodiment of the present inventions.

FIG. 3 is a block diagram illustrating components of an exemplary online learning system according to one embodiment of the present disclosure.

FIG. 4 is a flowchart illustrating an exemplary process for conducting online learning according to one embodiment of the present disclosure.

FIG. 5 is a flowchart illustrating additional details of an exemplary process for defining a study plan according to one embodiment of the present disclosure.

FIG. 6 is a flowchart illustrating additional details of an exemplary process for providing a dynamically spaced retrieval activity of an online learning session according to one embodiment of the present disclosure.

FIG. 7 is a flowchart illustrating additional details of an exemplary process for adjusting a lesson plan according to one embodiment of the present disclosure.

FIGS. 8A-8L illustrate a series of user interface graphics that may be presented during an online learning process according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

Embodiments of the present disclosure provide systems and methods for online learning in which a review or retrieval activity is performed a dynamically variable intervals to re-enforce learning and retention. As will be described in detail below, a study plan can be developed and customized for individual students. Content for a course of study can be presented according to this study plan as a sequence of activities including a study activity to present the course content and a retrieval activity to review and assess the student's mastery and retention of the content. A time interval between the study activity and the retrieval activity can be variable and dynamically determined based on the individual student's performance. In some embodiments, Artificial Intelligence (AI) models may be utilized to receive system inputs then determine dynamic adjustments to make for the study plan and the dynamic adjustments may be made automatically by the system or with student approval. Alternatively or additionally, one or more instruction sets may be used to determine dynamic adjustments to make for the study plan.

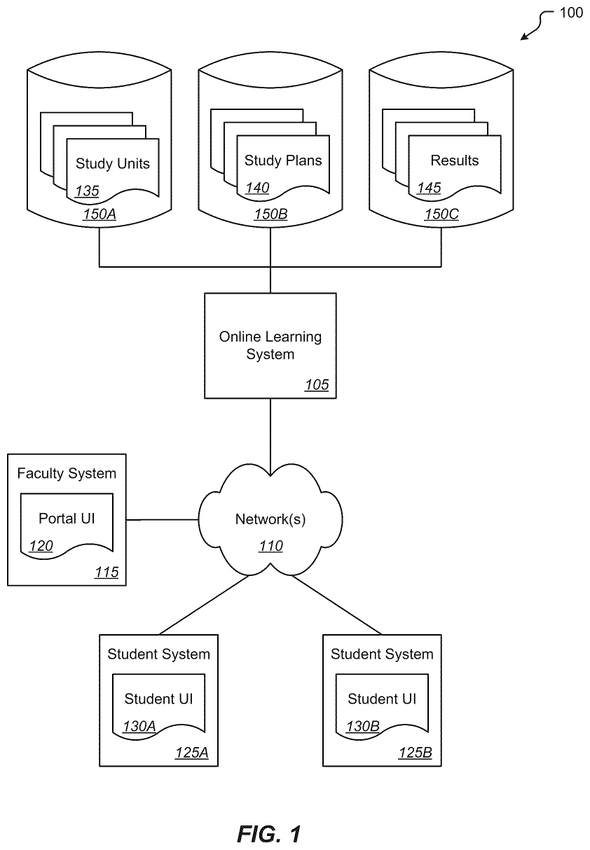

FIG. 1 is a block diagram illustrating elements of an exemplary online learning environment in which embodiments of the present disclosure may be implemented. As illustrated in this example, the online learning environment 100 can include an online learning system 105. The online learning system 105 can comprise any number of co-located and/or distributed servers and/or other computers as known in the art. The online learning system 105 can be communicatively coupled with one or more networks 110 such as the Internet or other wired or wireless, wide-area or local-area networks or combinations thereof.

Also coupled with the network(s) 110 can be one or more faculty systems 115 and any number of student systems 125A and 125B. The faculty system 115 and the student systems 125A and 125B can comprise any of a wide variety of computing devices as known in the art including, but not limited to, personal computers, laptop computers, tablets, smartphones, etc. Generally speaking, the online learning system 105 can provide a portal user interface 120 such as one or more webpages or other graphical and/or textual presentations to the faculty system 115. Through this portal user interface 120, a user (not shown here) of the faculty system 115 can interact with online learning services provided by the online learning system 105. Similarly, the online learning system 105 can provide a student user interface 130A and 130B such as one or more webpages or other graphical and/or textual presentations to the student systems 125A and 125B. Through this student user interface 130A and 130B, users (not shown here) of the student systems 125A and 125B can interact with online learning services provided by the online learning system 105.

As introduced above, the services provided by the online learning system 105 can allow a teacher or other user of the faculty system 115 and a student user of a student system 125A to develop study plan customed to that user of the student system 125A. For example, the user of the faculty system 115 can identify a set of content for a course of study, e.g., by uploading content, providing links, etc., to the online learning system 105 via the portal user interface 120. The online learning system can obtain this content and divide it into a set of study units 135 maintained in one or more repositories 150A. A user of the student system 125A can also provide input through the student user interface 130A that the online learning system 105 can use to develop a study plan 140 for that student user. Such study plans 140 can also be stored in a repository 150B. Based on the study plan 140, the online learning system 105 can present the study units 135 to the user of the student system 125A through the student user interface 130A, track performance of that user, and store a set of results information 145 in a repository 150C based on the tracking of the user's performance. It should be noted that while repositories 150A, 150B, and 150C storing the study units 135, study plans 140, and results information 145 as separate, these repositories 150A, 150B, and 150C can be separate or combined as one or more depending on the exact implementation.

More specifically, through the student user interface 130A, the user of the student system 125A can set a study goal and select the content they will study. The online learning system 105 divides content into study units 135 and allows the user of the student system 125A to create a study plan 140 that advances with user progress or set a start and end dates for the plan. The online learning system 105 can then calculate the weekly study progress necessary to meet the end date and study goal. The study plan 140 can organize groups of study units 135 by topic to preserve conceptual flow of the content into the order of desired study. The study plan 140 can also encourage the user to complete the most challenging content first to maximize engagement with the content over time.

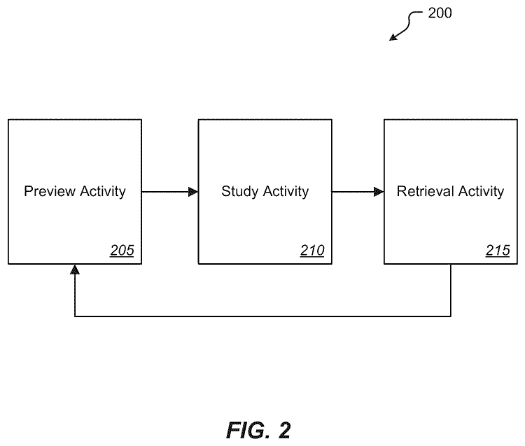

FIG. 2 is a block diagram conceptually illustrating an exemplary progression though online learning activities according to one embodiment of the present inventions. As introduced above, the online learning system 105 can present the study units 135 based on the study plan 140 in a sequence 200 of activities. In summary, these activities can include a preview activity 205, a study activity 210, and a retrieval activity 215. This sequence 2000 repeats as the user of the student system 125 progress through the study plan 140.

Generally speaking, the user of the student system 125 starts each cycle of this sequence with a study activity 210 that presents one or more study units 135. This presentation can comprise presenting the content of the study unit 135 which may be in the form of textual content, slide shows, videos, flashcards, quizzes, etc. The sequence 200 then progresses to a retrieval activity 215 which reviews a previously presented study unit 135. This presentation may be in the form of a question-and-answer quiz on the study unit contents, a replay of some or all of the content, or some combination thereof. Next, the sequence progresses to a preview activity 205 to prepare for the next study session. The preview activity can present some or all of a study unit 135 to be presented next according to the study plan. In some cases, the preview activity can prompt the user with content preview questions. This preview activity prepares their mind for the next study session when they will study the content from which the preview questions are derived. It should be understood that for an initial session, the sequence 200 may start with a preview activity 205 rather than a study activity 210.

As introduced above, the timing between presenting a study unit 135 in a study activity 210 and again in a retrieval activity 215 is variable and can be dynamically determined. Study units 135 previously completed can be presented in a retrieval activity 215 several days after being covered in the study activity 210 and reappear several times over progressively longer periods based on the performance of the user of the student system 125.

Accordingly, every time the user of the student system 125 interacts with the online learning system 105, a specific set of metrics can be recorded for each study unit 135 during each activity of the sequence 200. These metrics can include, but are not limited to, duration of engagement with each study unit, average duration of engagement by other users. duration of engagement with each question in a quiz or question-and-answer presentation, questions answered correctly, the percent of other users who answered the same question correctly, the confidence level of each question answered, and/or others. The online learning system 105 can assess and organize inputs and output updates to control when a particular study unit reappears in a retrieval activity 215 (e.g., a missed question will next reappear sooner rather than later) and which overall timing protocol for the retrieval activity 215 is in effect (i.e., overall shorter or longer intervals between study unit/question reappearance).

The retrieval activity 215 can also present feedback to the user of the student system 125 that can include, but is not limited to a strength factor report, encouraging messaging as needed, etc. Additionally, or alternatively, this feedback can include a Q&A report showing, for example, all questions, correctness of answers, confidence level of each answer, recommendations on further study, and/or others. In yet another example, the feedback can additionally, or alternatively include an updated status of progress toward a goal which can be presented, for example, on a timeline page.

The strength factor report mentioned above may correspond to an electronic document, report, or collection of reports. The strength factor report may provide feedback information to the user of the student system (e.g., the student) and/or to a third-party, such as an admissions officer or director of a medical residency program. The strength factor report may include information describing the student's study strength, the student's focus strength, or some other numerical reflection of a student's ability to engage with and absorb content presented by the online learning system 105. More specifically, but without limitation, the strength factor report may provide a score that is computed based on one or more of the following input variables: the student's study diligence, the student's engagement with the study materials, the student's accuracy with practice questions, how often the student's study pace has been adjusted (upward or downward), if the student remains on task, etc. These input variables may be automatically tracked by the online learning system 105 as the student interacts with the online learning system 105. The output of the strength factor report may provide a mechanism for predicting whether a student will have particular or desired study habits, which can equate to success in later programs, such as a residency.

In some cases, the online learning system 105 can also present a periodic check in which can encourage the user of the student system 125 to reflect on their progress, their current status toward their goal, and to mentally consider and prepare for their upcoming study activities. For example, every seven days, the user of the student system 125 can be presented with a check in to assess their current progress toward their end date and goal. The check in provides a report of their progress in the past week and notifies the user whether their current study pace is consistent with the recommended pace to meet their goal. If a user's pace for the previous week is below the recommended pace, they can receive a warning that their pace is low and a new pace for the upcoming week is recommended. The new recommended pace can be calculated based on their original goal/end date and their actual progress to date. Users are prompted to set a new study pace for the coming week and are not restricted to comply with the recommendation but are notified that their goal is in jeopardy by a lower pace. Upon selecting a new study pace, the study plan 410 for the user of the student system 125 can be updated with the next set of study units for the coming week.

The learning process continues as users of the student systems 125 preview, study, and review study units 135 progressively through targeted time intervals optimizing learning and memory retention. Their study plan 140 can be dynamically adjusted by the online learning system 105 periodically, e.g., weekly, with updated study pacing that allows a user to adjust for unexpected progress or delay in their personal study schedule and accommodates progress fluctuations to help them achieve their study goal. The online learning system 105 can provide through the student user interface 130 a timeline view of their study material, dates and goals, and study pacing with a larger view of the overall study plan and a means of quickly assessing progress toward the goal. With an overall view of their study plan 140, reflective check ins, and regular study activities at engaging strategic time intervals, the online learning system 105 can guide users of the student systems 125 through study practices improving their learning without the burden of administering a complex and unchanging or difficult to change study schedule.

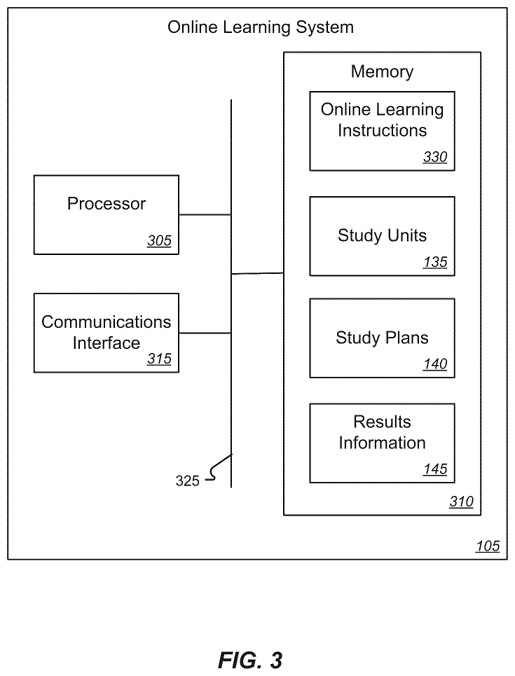

FIG. 3 is a block diagram illustrating components of an exemplary online learning system according to one embodiment of the present disclosure. As illustrated in this example, the online learning system 105 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the online learning system 105 as described herein.

The memory 310 can be coupled with and readable by the processor 305 via a communications bus 325. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communications interfaces 315. The communication interfaces 315 can comprise, for example, Ethernet, Bluetooth, WiFi, or other type of wired or wireless communications interfaces.

The memory 310 can store therein a set of online learning instructions 330 which, when executed by the processor 305, causes the processor 305 to maintain a set of study units 135 in one or more repositories. As noted above, each study unit of the set of study units can comprise a collection of related content.

The online learning instructions 330 can further cause the processor 305 to define a study plan 140 comprising a sequence of a plurality of study units from the set of study units 135 to be completed within a specified period of time and a pace defining a timeline for completing the sequence of the plurality of study units in the study plan within the specified period of time. Defining the study plan 140 can comprise receiving information defining one or more study goals for the user of the student system 125, receiving a selection of content for the set of study units, dividing the received selection of content into individual study units of the set of study units, organizing the plurality of study units in the lesson plan into an order defined by the study plan, receiving a start date and an end date for the specified period of time for the study plan, and calculating the pace for the study plan based on the start date and the end date for the specified period of time and the plurality of study units in the study plan.

The online learning instructions 330 can further cause the processor 305 to provide to a student system 125, via the communication interface 315, a study activity based on the study plan 140. The study activity can comprise presentation of at least one study unit from the sequence of the plurality of study in the study plan 140 to a user of the student system 125. In some cases, the online learning instructions 330 can further cause the processor to provide a preview activity comprising a presentation of one or more next study units 135 in the study plan 140 before providing the study activity.

The online learning instructions 330 can further cause the processor 305 to provide a retrieval activity comprising presentation of the at least one study unit 135 from the study activity after the study activity is completed. A time interval between completion of the study activity and the retrieval activity can be dynamically determined based performance of the user of the student system 125. Providing the retrieval activity can comprises collecting a set of metrics from results in formation 145 for the study activity. The set of metrics can indicate performance of the user of the student system 125. The online learning instructions 330 can further cause the process or 305 to determine the time interval between completion of the completed study unit and the retrieval activity based on the set of metrics, provide the presentation of the at least one study unit to the student system, provide feedback on the retrieval activity based on performance of the user of the student system during the retrieval activity, and update the set of metrics in the results information 145 based on the performance of the user of the student system 125 during the retrieval activity.

The online learning instructions 330 can further cause the processor 305 to track results of the study activity and the retrieval activity and adjust the study plan 140 based on the tracking of the results of the study activity and the retrieval activity. Adjusting the study plan 140 can comprise providing a summary of current performance of the user of the student system 125 on the study plan, i.e., based on the results information 145, and determining, based on the current performance of the user of the student system on the study plan, whether the user of the student system is on the pace defined for the study plan. In response to determining the user of the student system is not on the pace defined for the study plan, the online learning instructions 330 can cause the processor 305 to suggest a new pace for the study plan to the user of the student system 125 through the student system, receive an indication of a selection of a new pace for the study plan 140 from the student system 125, and update the study plan 145 with the new pace.

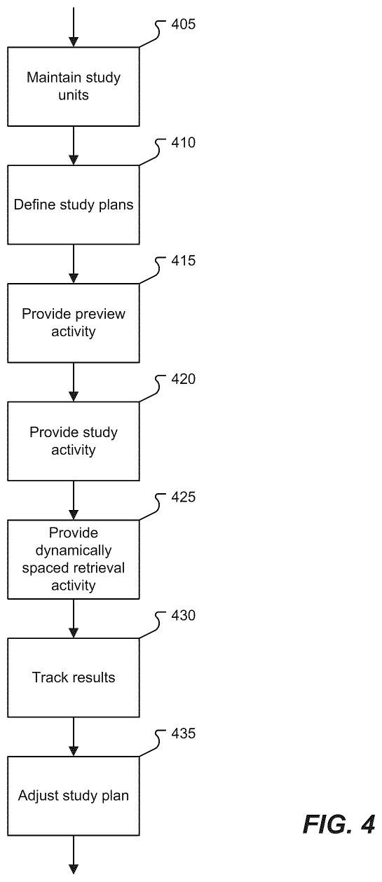

FIG. 4 is a flowchart illustrating an exemplary process for conducting online learning according to one embodiment of the present disclosure. As illustrated in this example, conducting online learning, as may be performed by an online learning system 105 as described above, can begin with maintaining 405 a set of study units 135 in one or more repositories 150. Each study unit 135 can comprise a collection of related content.

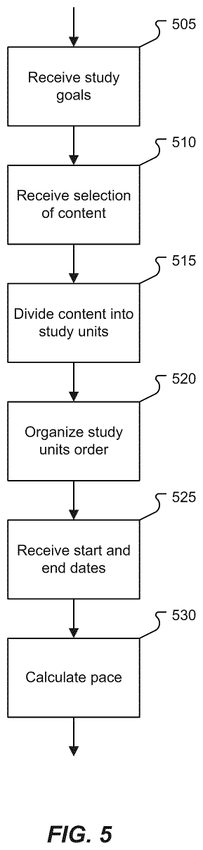

A study plan 140 using the study units 135 can be defined 410. The study plan can comprise a sequence of a plurality of study units 135 from the set of study units to be completed within a specified period of time and a pace defining a timeline for completing the sequence of the plurality of study units 135 in the study plan 140 within the specified period of time. Additional details of an exemplary process for defining 410 a study plan 140 will be described below with reference to FIG. 5.

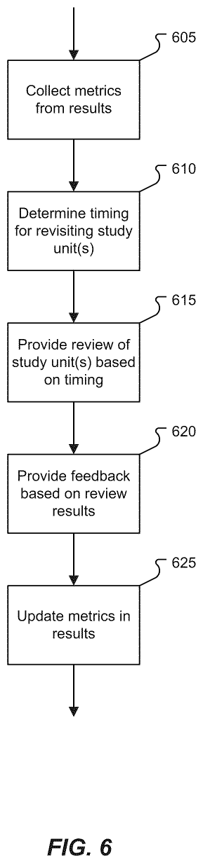

In some cases, a preview activity can be provided 415. The preview activity can comprise a presentation of some part of or a whole one or more next study units 135 in the study plan 140, i.e., to demonstrate to introduce the next study unit. At a later time, a study activity can be provided 420 to a student system 125 based on the study plan 140. The study activity can comprise presentation of at least one study unit from the sequence of the plurality of study units 135 in the study plan 140 to a user of the student system 125. At yet another, later point in time, a retrieval activity can be provided 425 to the student system 125. The providing 425 the retrieval process can comprise presentation of the at least one study unit from the study activity after the study activity is completed. A time interval between completion of the study activity and the retrieval activity can be dynamically determined based performance of the user of the student system 125. Additional details of an exemplary process for providing 425 a retrieval process will be described below with reference to FIG. 6.

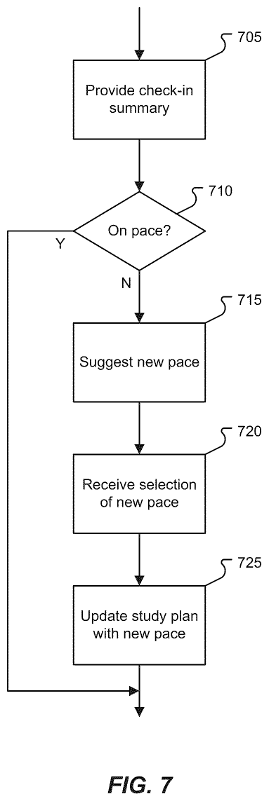

Results of the study activity and the retrieval activity can be tracked 430 and the study plan 140 can be adjusted 435 based on the tracking of the results of the study activity and the retrieval activity. For example, the pace can be adjusted if the user of the student system 125 has fallen behind of or exceeded the previously determined pace. Additional details of an exemplary process for adjusting 435 the student plan 140 will be described below with reference to FIG. 7.

FIG. 5 is a flowchart illustrating additional details of an exemplary process for defining a study plan according to one embodiment of the present disclosure. As illustrated in this example, defining the study plan can begin with receiving 505 information defining one or more study goals for the user of the student system 140 and receiving 510 a selection of content for the set of study units 135. The information defining the study goals as well as the selection of content can be provided by either or both of a faculty system 115 and/or a student system 125.

The received selection of content can be divided 515 into individual study units 135 of the set of study units, e.g., by dividing, combining, sorting, etc., content based on topic, sub-topic, content type, etc. The plurality of study units 135 in the lesson plan 135 can then be organized 520 into an order in which they should be provided and which can be defined by the study plan 140. This order can be received from either or both of a faculty system 115 and/or a student system 125. Additionally, or alternatively, he order can be determined based on topics of the study units and a predefined curriculum or course of study.

A start date and an end date for the specified period of time for the study plan can be received 525 from either or both of a faculty system 115 and/or a student system 125. The pace for the study plan can be calculated 530 based on the start date and the end date for the specified period of time, the number of study units 135 in the study plan 140, an estimated time needed for each study unit 135, if available, and/or other factors.

FIG. 6 is a flowchart illustrating additional details of an exemplary process for providing a dynamically spaced retrieval activity of an online learning session according to one embodiment of the present disclosure. As illustrated in this example, providing the retrieval activity can begin with collecting 605 a set of metrics from the results information 145 for the study activity. The set of metrics can indicate performance of the user of the student system 125 during one or more past study activities and/or retrieval activities. These metrics can include, but are not limited to, a duration of engagement with each study unit, a number of correct and/or incorrect answers to questions presented in the study activities and/or retrieval activities, a percent of other users answer the same question correctly or incorrectly, an indication of a confidence level for each answer, etc.

A time interval between completion of the completed study activity and the retrieval activity can be determined based on the set of metrics. For example, a high level of engagement and a high percentage of correct answers may mean that a longer period is possible and may even be preferable while metrics indicating poor retention and performance may indicate a need for a shorter period before another retrieval activity on the same study unit.

Once the determined time interval has passed since completion of the study activity for the give study unit, a presentation of that study unit can be provided 615 to the student system. This presentation may be in the form of a question-and-answer quiz on the study unit contents, a replay of some or all of the content, or some combination thereof. Meanwhile, performance on the retrieval activity can continue to be tracked as described above.

Upon completion of the retrieval activity, feedback can be provided 620 based on performance of the user of the student system during the retrieval activity. This feedback can take the form of a quiz score, indications of right and/or wrong answers, indications for areas for further study, etc. Additionally, the set of metrics in the results information 145 can be updated based on the performance of the user of the student system during the retrieval activity.

FIG. 7 is a flowchart illustrating additional details of an exemplary process for adjusting a lesson plan according to one embodiment of the present disclosure. As illustrated in this example, adjusting the study plan can begin with providing 705 a summary of current performance of the user of the student system on the study plan. This summary can be generated from and based on the results information 140 and can be presented to the user through the student system 125. A determination 710 can be made based on the current performance of the user of the student system on the study plan as to whether the user of the student system is on the pace defined for the study plan, i.e., a determination of whether the has user successfully completed all of the study units scheduled to be completed by the current time as indicated in the study plan 140.

In response to determining 710 the user of the student system is not on the pace defined for the study plan, either by being ahead or behind the schedule indicated in the study plan, a new pace for the study plan can be suggested 715 to the user through the student system 125. This suggestion may be generated in a way similar to how the pace was originally determined, i.e., based on the current time, the designated end time, the number of study units remaining an expected time for each, etc. Additionally, or alternatively, the suggestion can comprise a request for the user to select of specify a new pace. In either case, an indication of a selected new pace can be received 720 if the user agrees and the study plan 140 can be updated 725 with the new pace.

Although FIG. 7 illustrates a determination 710 that results in the study plan 140 plan being updated, it should be appreciated that the study plan 140 can be updated 725 even if the user is on pace or ahead of pace. In other words, the method illustrated in FIG. 7 is also contemplated to cover a scenario where a user is currently on or head of pace (e.g., where the determination 710 is made affirmatively). Following a determination that the user is currently on or ahead of pace, the student system 125 may still enable pace adjustments or suggest pace adjustments to the user. As an example, the student system 125 may be configured to automatically adjust a pace or suggest an adjusted pace, regardless of whether or not the user is on pace with their study plan 140. Such automated adjustments or recommendations (for approval by the user) may be implemented on a periodic basis (e.g., every day, every three days, every week, etc.). The automated adjustments or recommendations may be delayed or pushed back if the user has recently adjusted the pace of their study plan 140, either proactively or in response to the student system 125 adjusting the pace for some reason or another. Thus, to be clear, the updating 725 of a user's study plan 140 may be dependent upon determination 710, but such a configuration is not required.

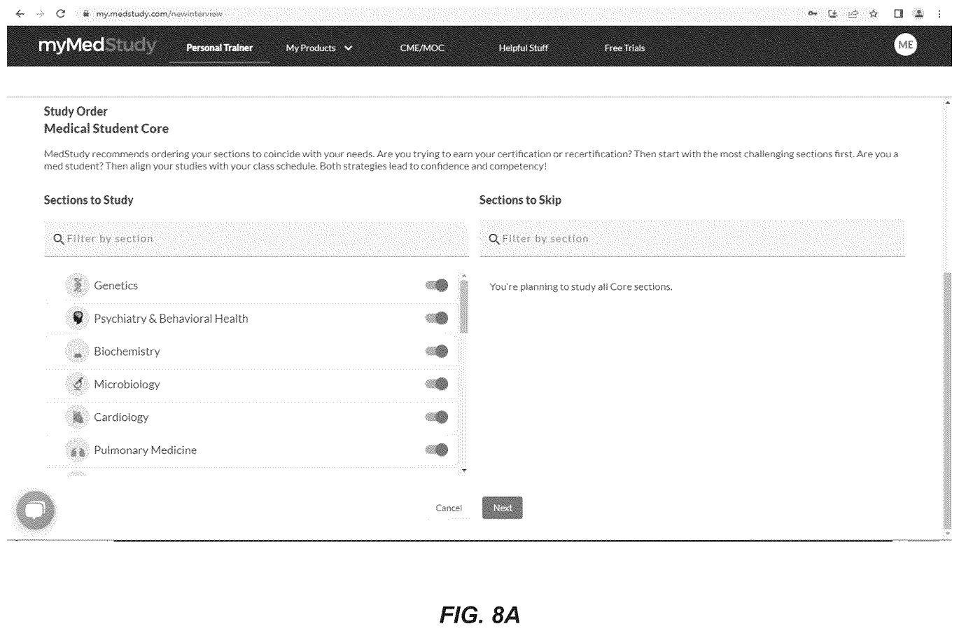

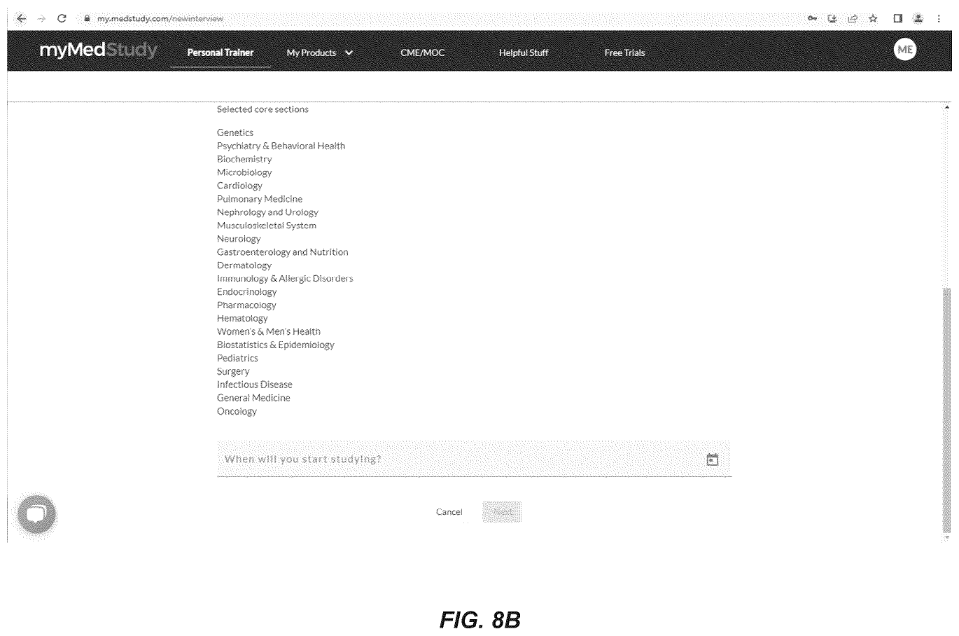

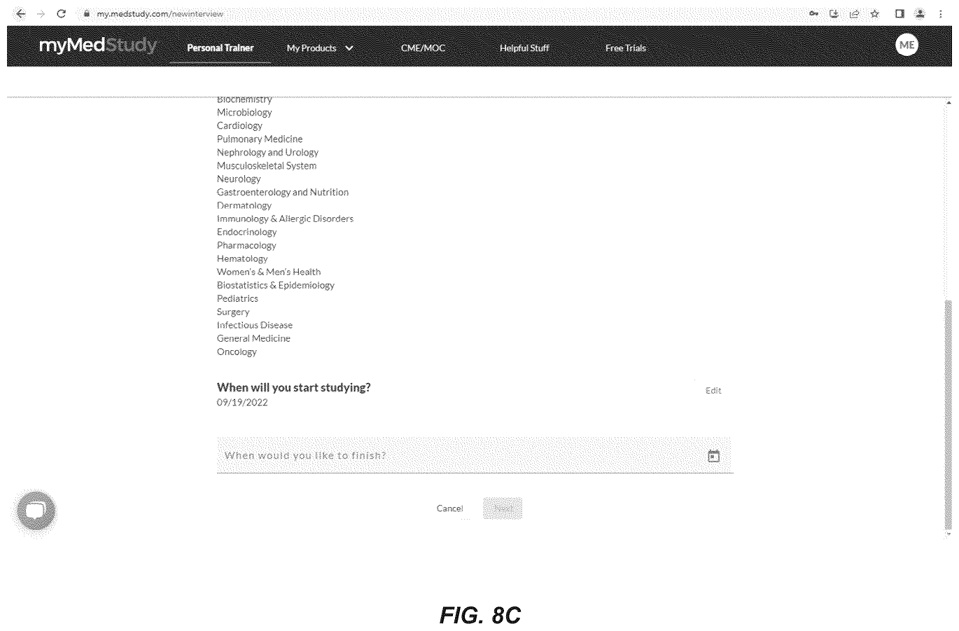

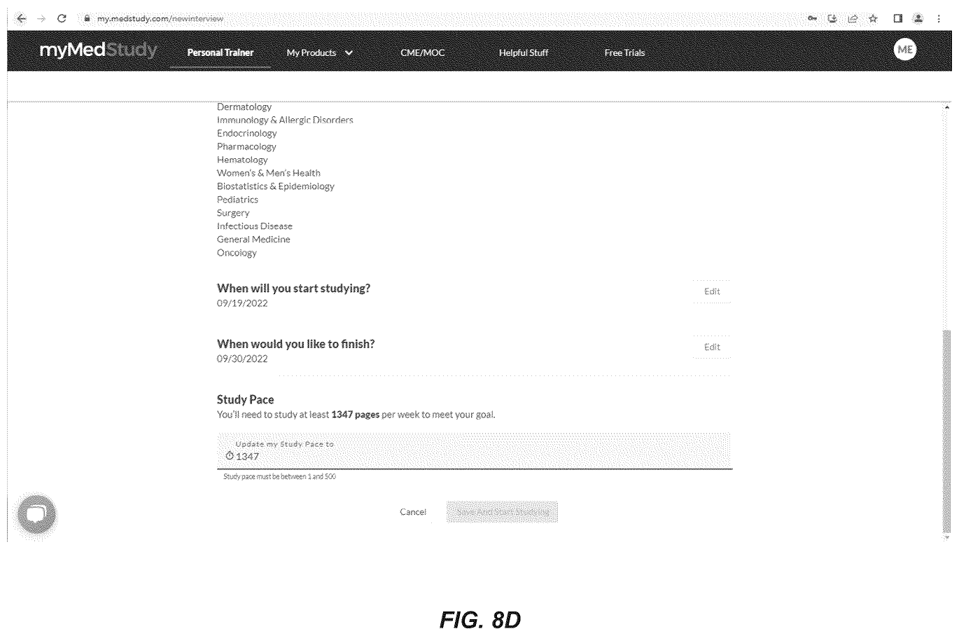

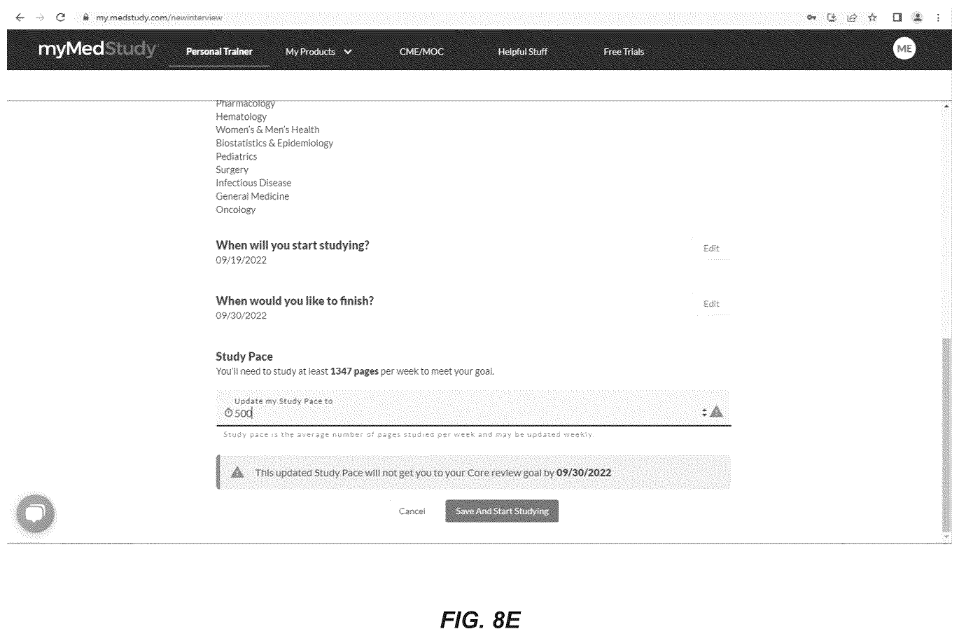

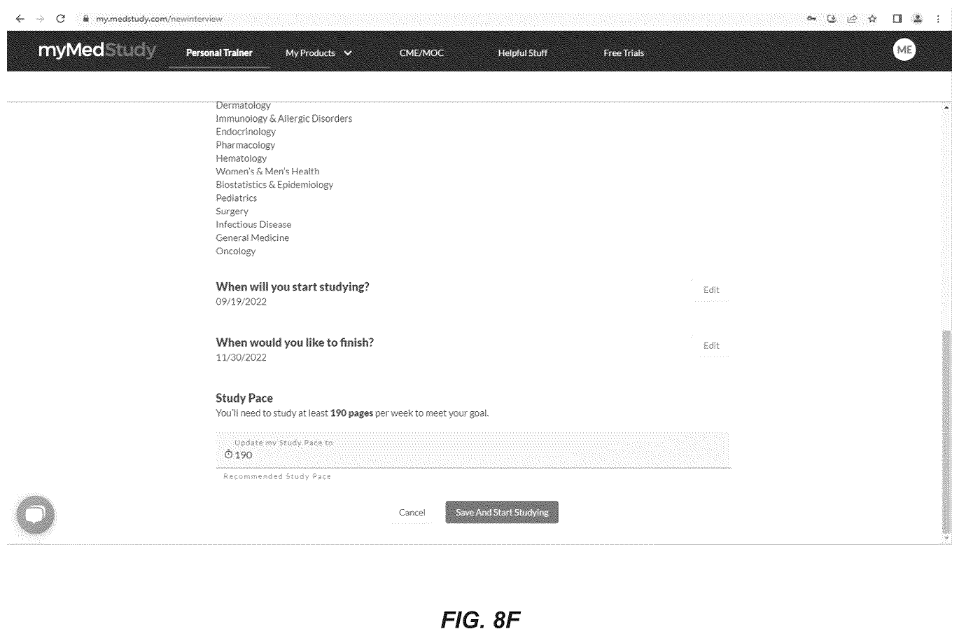

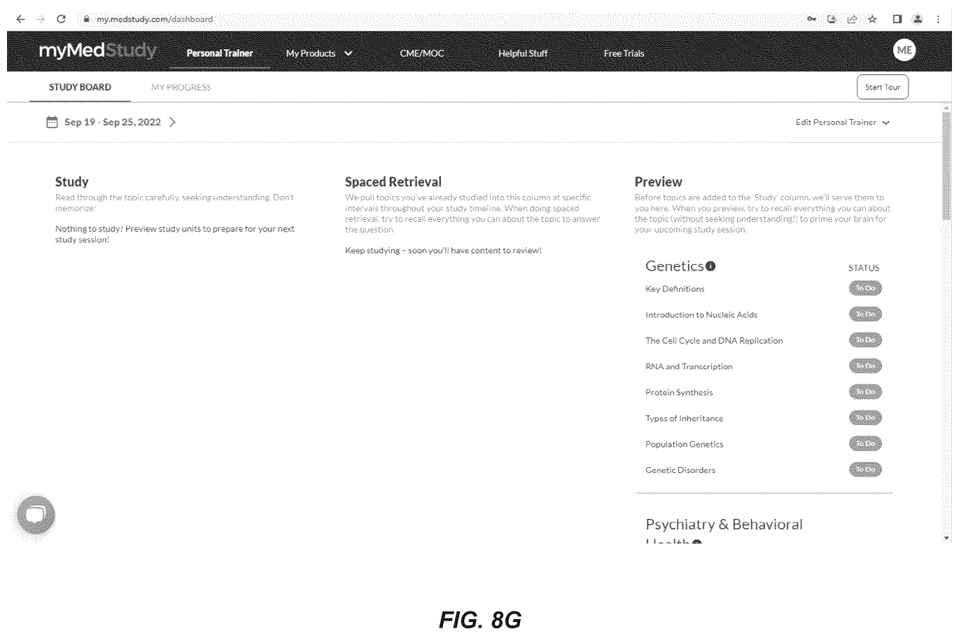

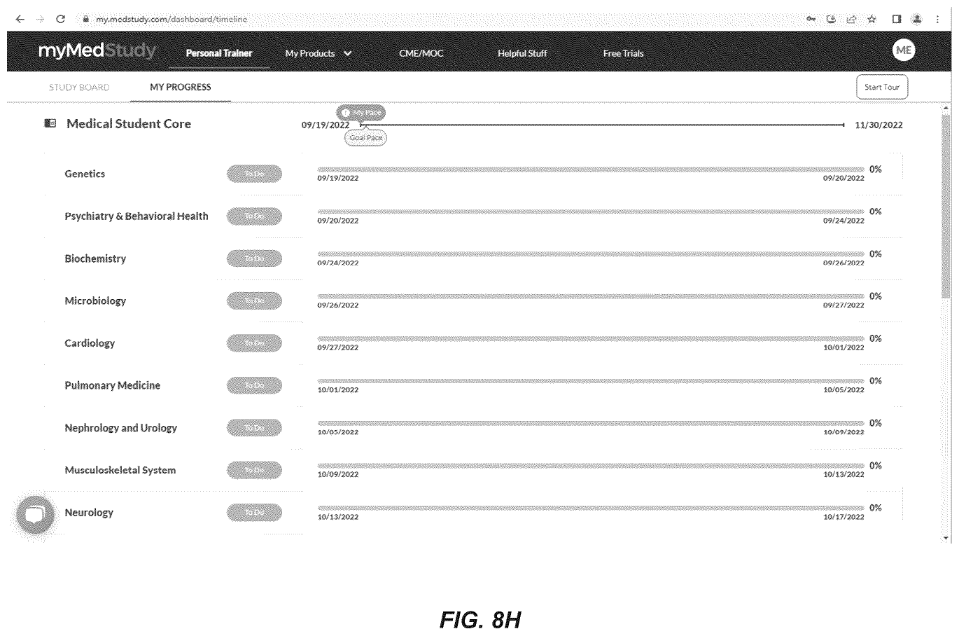

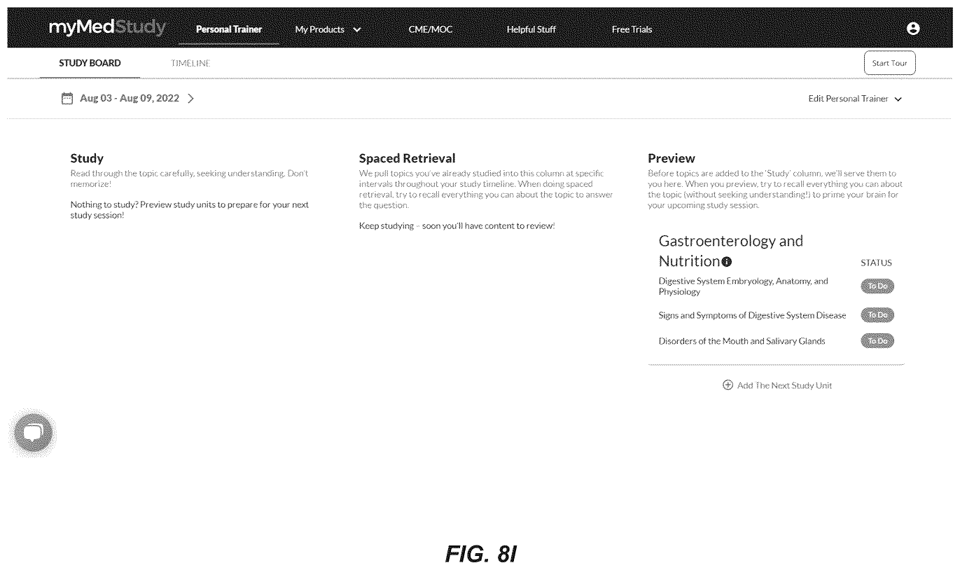

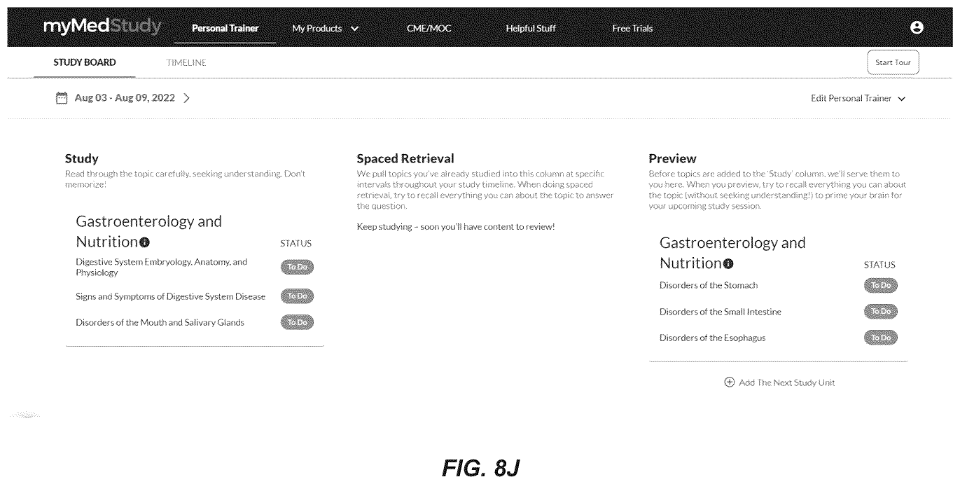

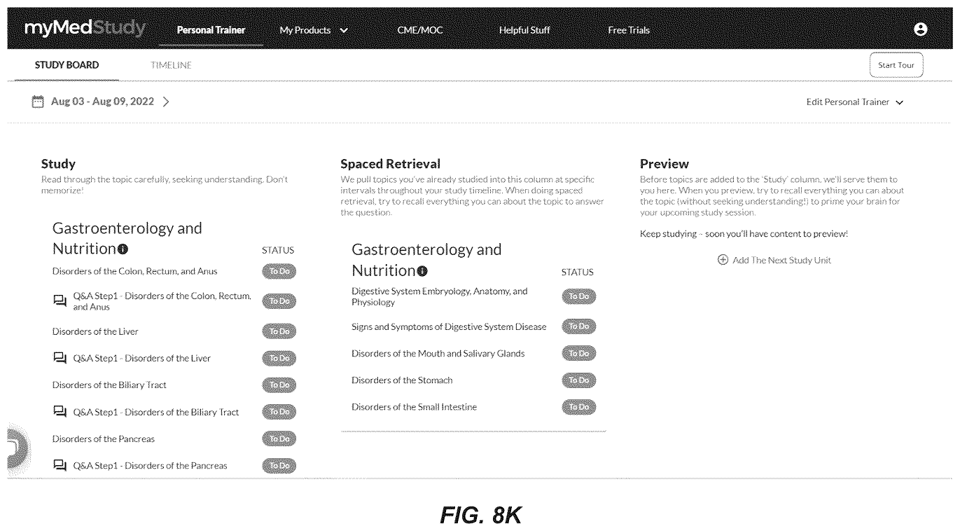

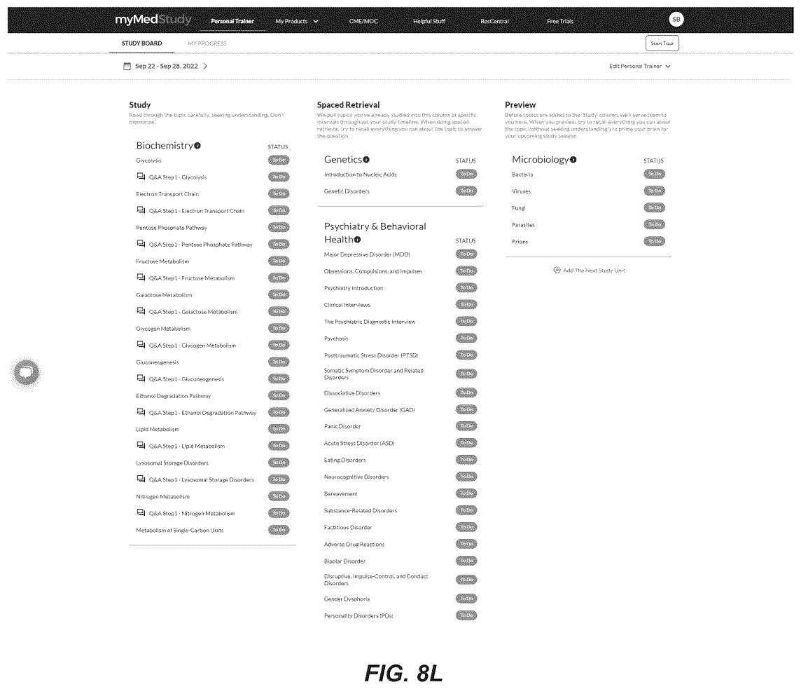

Additional details of the above-described methods are further understood with reference to FIGS. 8A-8L, which illustrate a series of user interface graphics that can be presented to a user to support the study plan 140. In some embodiments, the user interface graphics may support the creation of a user's profile and the initialization of the study plan 140 for the user (e.g., FIGS. 8A-8F). The user interface graphics may also support automated feedback that enables the user to determine if their desired study period is infeasible, feasible, too much work per day, etc., and the determination may be made with respect to initial study and spaced retrieval study activities (e.g., FIGS. 8D-8H). In some embodiments, the user may be presented with one or more progress bars that are updated daily based on user progress, both overall and within particular topics. The system may also be intelligent enough to determine if dynamic adjustments to spaced retrieval parameters should be made and/or whether or not to remove topics from the student's syllabus based on current progress. The system may also enforce thresholds related to a number of days available to study, a number of pages of material that can be studied in a given day, a number of subjects that can be studied in a given day, a number of spaced retrieval topics that may be studied in a day, combinations thereof, and the like. Presentation of the unique graphical user interface may provide the user with a simple and digestible presentation of data representing their study progress over along amount of time and with respect to a large number of subjects.

FIGS. 8I-8L are particularly useful in showing that topics of a study plan 140 can automatically migrate from one section of the user interface to another as the user progresses through the study plan 140. In particular, FIG. 81 illustrates a user interface in which the study column and the spaced retrieval column are not populated with a topic, since the user has yet to begin studying a topic. In this state, the preview column is the only column that contains topics for the user. As topics are previewed, they may automatically transition from the preview column (and the window presenting the same) into the study column as shown in FIG. 8J. The content presented to the user for these topics will change as the topic automatically migrates from the preview column to the study column. In particular, further content may be presented to the user in connection with a topic when that topic resides in the study column. Examples of further content include more detailed textual content, additional study slides, quizzes, tests, etc. Once a user completes a topic in the study column, the topic may automatically be removed from the study column, but not necessarily automatically placed into the spaced retrieval column. While FIGS. 8K and 8L illustrate topics in the study column and the spaced retrieval column, it should be appreciated that other topics that have just been removed from the study column may not be automatically placed into the spaced retrieval column. For example, topics may wait in a non-presented state for a predetermined amount of time before being placed into the spaced retrieval column. As another example, depending upon how well the user interacted with the topic in the study column, the amount of time that transpires before placing the topic in the spaced retrieval column may vary. Illustratively, topics completed with higher accuracy in the study column may wait longer (e.g., a week) before being automatically populated in the spaced retrieval column whereas topics completed with lower accuracy in the study column may wait less (e.g., two days) before being automatically populated in the spaced retrieval column. The number of topics in the spaced retrieval column may also control when additional topics are added to the spaced retrieval column. For instance, a threshold may be defined to control a maximum number of topics that can be placed in the spaced retrieval column. As topics are studied from the spaced retrieval column, a new topic may be added, depending upon which topics are next up for inclusion in the spaced retrieval column.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for conducting online learning, the method comprising:
maintaining, by a processor of an online learning system, a set of study units in one or more repositories, each study unit of the set of study units comprising a collection of related content;
defining, by the processor of the online learning system, a study plan comprises a sequence of a plurality of study units from the set of study units to be completed within a specified period of time and a pace defining a timeline for completing the sequence of the plurality of study units in the study plan within the specified period of time;
providing, by the processor of the online learning system, to a student system, a study activity based on the study plan, wherein the study activity comprises presentation of at least one study unit from the sequence of the plurality of study in the study plan to a user of the student system; and
providing, by the processor of the online learning system, a retrieval activity comprising presentation of the at least one study unit from the study activity after the study activity is completed, wherein a time interval between completion of the study activity and the retrieval activity is dynamically and automatically determined based performance of the user of the student system.

2. The method of claim 1, further comprising providing, by the processor of the online learning system, a preview activity comprising a presentation of one or more next study units in the study plan.

3. The method of claim 1, wherein defining the study plan further comprises:
receiving information defining one or more study goals for the user of the student system;
receiving a selection of content for the set of study units;
dividing the received selection of content into individual study units of the set of study units;
organizing the plurality of study units in the lesson plan into an order defined by the study plan;
receiving a start date and an end date for the specified period of time for the study plan; and
calculating the pace for the study plan based on the start date and the end date for the specified period of time and the plurality of study units in the study plan.

4. The method of claim 1, further comprising tracking, by the processor of the online learning system, results of the study activity and the retrieval activity.

5. The method of claim 4, wherein providing the retrieval activity further comprises:
collecting a set of metrics from the results of the study activity, the set of metrics indicating performance of the user of the student system;
determining time interval between completion of the completed study unit and the retrieval activity based on the set of metrics;
providing the presentation of the at least one study unit to the student system;
providing, through the student system, feedback on the retrieval activity based on performance of the user of the student system during the retrieval activity; and
updating the set of metrics in the results based on the performance of the user of the student system during the retrieval activity.

6. The method of claim 4, further comprising adjusting, by the processor of the online learning system, the study plan based on the tracking of the results of the study activity and the retrieval activity.

7. The method of claim 6, wherein adjusting the study plan further comprises:
providing a summary of current performance of the user of the student system on the study plan;
determining, based on the current performance of the user of the student system on the study plan, whether the user of the student system is on the pace defined for the study plan;
in response to determining the user of the student system is not on the pace defined for the study plan, suggesting a new pace for the study plan to the user of the student system through the student system, receiving an indication of a selection of a new pace for the study plan from the student system, and updating the study plan with the new pace.

8. A system comprising:
a processor; and
a memory coupled with and readable by the processor and storing therein a set of instructions which, when executed by the processor, causes the processor to:
maintain a set of study units in one or more repositories, each study unit of the set of study units comprising a collection of related content;
define a study plan comprises a sequence of a plurality of study units from the set of study units to be completed within a specified period of time and a pace defining a timeline for completing the sequence of the plurality of study units in the study plan within the specified period of time;
provide to a student system, a study activity based on the study plan, wherein the study activity comprises presentation of at least one study unit from the sequence of the plurality of study in the study plan to a user of the student system; and
provide a retrieval activity comprising presentation of the at least one study unit from the study activity after the study activity is completed, wherein a time interval between completion of the study activity and the retrieval activity is dynamically determined based performance of the user of the student system.

9. The system of claim 8, wherein the instructions further cause the processor to provide a preview activity comprising a presentation of one or more next study units in the study plan.

10. The system of claim 8, wherein defining the study plan further comprises:
receiving information defining one or more study goals for the user of the student system;
receiving a selection of content for the set of study units;
dividing the received selection of content into individual study units of the set of study units;
organizing the plurality of study units in the lesson plan into an order defined by the study plan;
receiving a start date and an end date for the specified period of time for the study plan; and
calculating the pace for the study plan based on the start date and the end date for the specified period of time and the plurality of study units in the study plan.

11. The system of claim 8, wherein the instructions further cause the processor to track results of the study activity and the retrieval activity.

12. The system of claim 11, wherein providing the retrieval activity further comprises:
collecting a set of metrics from the results of the study activity, the set of metrics indicating performance of the user of the student system;
determining time interval between completion of the completed study unit and the retrieval activity based on the set of metrics;
providing the presentation of the at least one study unit to the student system;
providing, through the student system, feedback on the retrieval activity based on performance of the user of the student system during the retrieval activity; and
updating the set of metrics in the results based on the performance of the user of the student system during the retrieval activity.

13. The system of claim 11, wherein the instructions further cause the processor to adjust the study plan based on the tracking of the results of the study activity and the retrieval activity.

14. The system of claim 13, wherein adjusting the study plan further comprises:
providing a summary of current performance of the user of the student system on the study plan;
determining, based on the current performance of the user of the student system on the study plan, whether the user of the student system is on the pace defined for the study plan;
in response to determining the user of the student system is not on the pace defined for the study plan, suggesting a new pace for the study plan to the user of the student system through the student system, receiving an indication of a selection of a new pace for the study plan from the student system, and updating the study plan with the new pace.

15. A non-transitory, computer-readable medium comprising a set of instructions stored therein which, when executed by a processor, causes the processor to:
maintain a set of study units in one or more repositories, each study unit of the set of study units comprising a collection of related content;
define a study plan comprises a sequence of a plurality of study units from the set of study units to be completed within a specified period of time and a pace defining a timeline for completing the sequence of the plurality of study units in the study plan within the specified period of time;
provide to a student system, a study activity based on the study plan, wherein the study activity comprises presentation of at least one study unit from the sequence of the plurality of study in the study plan to a user of the student system; and
provide a retrieval activity comprising presentation of the at least one study unit from the study activity after the study activity is completed, wherein a time interval between completion of the study activity and the retrieval activity is dynamically determined based performance of the user of the student system.

16. The non-transitory, computer-readable medium of claim 15, wherein the instructions further cause the processor to provide a preview activity comprising a presentation of one or more next study units in the study plan.

17. The non-transitory, computer-readable medium of claim 15, wherein defining the study plan further comprises:
receiving information defining one or more study goals for the user of the student system;
receiving a selection of content for the set of study units;
dividing the received selection of content into individual study units of the set of study units;
organizing the plurality of study units in the lesson plan into an order defined by the study plan;
receiving a start date and an end date for the specified period of time for the study plan; and
calculating the pace for the study plan based on the start date and the end date for the specified period of time and the plurality of study units in the study plan.

18. The non-transitory, computer-readable medium of claim 15, wherein the instructions further cause the processor to track results of the study activity and the retrieval activity.

19. The non-transitory, computer-readable medium of claim 18, wherein providing the retrieval activity further comprises:
collecting a set of metrics from the results of the study activity, the set of metrics indicating performance of the user of the student system;
determining time interval between completion of the completed study unit and the retrieval activity based on the set of metrics;
providing the presentation of the at least one study unit to the student system;
providing, through the student system, feedback on the retrieval activity based on performance of the user of the student system during the retrieval activity; and
updating the set of metrics in the results based on the performance of the user of the student system during the retrieval activity.

20. The non-transitory, computer-readable medium of claim 18, wherein the instructions further cause the processor to adjust the study plan based on the tracking of the results of the study activity and the retrieval activity, wherein adjusting the study plan further comprises:
providing a summary of current performance of the user of the student system on the study plan;
determining, based on the current performance of the user of the student system on the study plan, whether the user of the student system is on the pace defined for the study plan; and
based, at least in part on determining whether the user of the student system is on the pace defined for the study plan, suggesting a new pace for the study plan to the user of the student system through the student system;
receiving an indication of a user selection made via a user interface regarding the new pace for the study plan suggested from the student system; and
updating the study plan with the new pace.
